(19) United States
(12) Patent Application Publication
(10) Pub. No.: US 2026/0316728 A1
(43) Pub. Date: Oct. 15, 2026

(54) METHOD FOR CONTROLLING A BRAKING SYSTEM OF A MULTI-AXLE VEHICLE

(71) Applicant: Robert Bosch GmbH, Stuttgart (DE)

(72) Inventors: Christian Woerz, Beilstein (DE); Franz Dahlke, Unkel (DE)

(21) Appl. No.: 19/637,041

(22) Filed: Apr. 2, 2026

(30) Foreign Application Priority Data
Apr. 15, 2025 (DE) 10 2025 114 648.9

(51) Int. Cl. B60T 8/26; B60T 8/171; B60T 8/172

(52) U.S. Cl. CPC B60T 8/26; B60T 8/171; B60T 8/172

(57) ABSTRACT

A method for controlling a braking system of a multi-axle vehicle. The braking system includes a plurality of brake actuators. The method includes: determining temperatures of the brake actuators; determining a braking force distribution between the brake actuators depending on the temperatures of the brake actuators; controlling the braking system depending on the determined braking force distribution. A corresponding electronic control unit, a corresponding computer program, and a corresponding machine-readable storage medium are also described.

### FIELD

The present application relates to a method for controlling a braking system of a multi-axle vehicle.

### BACKGROUND INFORMATION

Modern vehicles increasingly use sophisticated braking systems that often integrate both friction brakes and regenerative braking functions. While regenerative braking offers advantages in terms of energy efficiency, it is not always available or sufficient to meet all braking needs. In situations such as a fully charged battery when driving downhill, maneuvering at low speed or when the vehicle is stopped, the friction brakes must bear the full braking load.

Conventional brake control systems typically use predefined standard braking force distributions. These standard braking force distributions primarily prioritize driving dynamics and stability, and maximize energy recovery where possible. However, these conventional approaches often neglect the thermal effects on individual brake actuators. Continuous or frequent braking can lead to significant heat generation in the actuators, in particular in challenging driving scenarios.

Excessive thermal stress can adversely affect the performance and lifespan of brake actuators. Elevated temperatures can, for example, cause reduced braking performance and increased wear. In extreme cases, thermal overload can lead to actuator failure, which impairs vehicle safety. This is particularly challenging with electromechanical braking systems, as their design and operation make them more susceptible to thermal stress than conventional hydraulic systems.

The present disclosure addresses this challenge through an approach to braking force distribution that takes into account the thermal state of the brake actuators.

Germany Patent Application No. DE 10 2004 008 384 A1 describes a method for controlling an electromechanical braking system with at least two actuators.

Germany Patent Application No. US 2019/0193571 A1 describes a method for controlling a braking system in which a total braking torque is divided between a first and a second axle.

### SUMMARY

A method for controlling a braking system of a multi-axle vehicle is provided, wherein the braking system comprises a plurality of brake actuators.

According to an example embodiment, in this process, temperatures of brake actuators are determined and a braking force distribution is determined as a function of the temperatures of the brake actuators. The braking system is then controlled depending on the determined braking force distribution.

This is advantageous because taking the temperature into account allows for a targeted reduction of the thermal load on individual actuators, thereby counteracting excessive heat generation, which significantly increases the service life of the brake components and reduces maintenance. At the same time, the reliability of the entire braking system is improved, as the risk of temperature-related failure is minimized. Furthermore, the braking process is optimized by using cooler actuators more effectively and reducing the overall effort required for braking operations.

In particular, the method can be implemented using computers.

Further advantageous example embodiments are disclosed herein.

Advantageously, the vehicle has at least two axles, each axle having at least one brake actuator, and a braking force distribution is determined such that a thermal load on at least one brake actuator of a first axle is reduced by increasing the load on at least one brake actuator of a second axle. This is advantageous because it prevents local overheating of individual actuators, in particular under high stress on an axle. For example, when driving downhill, the front axle can be relieved of load by increasing the load on the rear axle. This proactive load balancing increases the service life and reliability of the braking system and contributes to improved safety by ensuring consistent braking behavior. Indirectly, energy consumption can also be optimized by a more even distribution of the braking load.

Advantageously, the braking force distribution between the brake actuators is determined as a function of the temperatures of the brake actuators if a temperature of the brake actuator of the first axle exceeds a predefined threshold value. This is advantageous because, firstly, it reduces the computational effort, as the algorithm for BKV adjustment is only activated when needed, and secondly, the threshold value allows precise control of the intervention and avoids unnecessary adjustments to the braking force distribution. Furthermore, the targeted intervention maximizes the lifespan of the actuators, as the thermal load is only reduced when it reaches a critical value.

It is convenient that the first axle is the front axle of the vehicle and the second axle is the rear axle of the vehicle. This is advantageous because it specifies the application of the present disclosure to the most common axle configuration in vehicles and clarifies the advantages of load shifting. If the front axle is overloaded, e.g., due to heavy braking or downhill driving, the braking force can be selectively shifted to the rear axle. This protects the front brakes from overheating and failure, which is particularly crucial for steering ability and therefore vehicle safety. At the same time, the defined axle configuration simplifies the implementation of the method, as the assignment of the actuators is clearly defined.

Advantageously, when determining the braking force distribution, it is checked whether the vehicle is stopped and a single axle is sufficient to maintain the stopped state, a braking force being applied only to one axle using a subset of actuators on that axle, switching being performed between a front axle and a rear axle and/or between different subsets of actuators on each axle to reduce thermal stress on the brake actuators. This is advantageous because the change between the front and rear axles, or between actuator groups on an axle, distributes the heat more evenly and promotes cooling. This increases the lifespan of the actuators and reduces the energy required for cooling. The improved heat distribution also contributes to the reliability of the braking system, in particular after high thermal loads.

It is advisable to check whether recuperation of braking energy is possible or not before determining the braking force distribution, the braking force distribution being determined if recuperation is not possible. This is advantageous because it avoids unnecessary interventions in the braking force distribution when recuperation already ensures sufficient cooling and load distribution. This reduces the computational effort and simplifies the control of the braking system.

In the event of a brake actuator failure, it is expedient to determine the braking force distribution between the remaining brake actuators without limitations on the braking force distribution. This is advantageous for vehicle safety in critical situations, as it ensures at least an emergency stop through controllable braking behavior and thus a safe stopped state of the vehicle, even under extreme thermal conditions. This ensures that vehicle safety is maintained for as long as possible in emergency situations.

Furthermore, the present disclosure relates to an electronic control unit which is configured to execute all steps of a method according to the present disclosure. This is advantageous because it allows efficient and reliable execution of the method. The control unit can, for example, acquire the necessary data, such as the temperatures of the brake actuators, execute the algorithm to calculate the braking force distribution, and send the control signals to the brake actuators. Integration into a dedicated control unit simplifies implementation into existing vehicle architectures and allows for optimal adaptation to the specific requirements of the braking system. This ensures the practical feasibility of the present disclosure.

Furthermore, the present disclosure relates to a computer program comprising commands which, when executed by a computer, cause the computer to execute a method according to the present disclosure. This allows for flexible adaptation to different control units and vehicle platforms.

Furthermore, the present disclosure provides a machine-readable storage medium on which the computer program according to the present disclosure is stored. Thus, the aforementioned advantages can be achieved.

### BRIEF DESCRIPTION OF THE DRAWINGS

Advantageous example embodiments of the present disclosure are illustrated in the figures and explained in more detail in the following description.

FIG. 1 is a flow chart of a method according to the present disclosure according to a first example embodiment.

FIG. 2 is a flow chart of a method according to the present disclosure according to a second example embodiment.

FIG. 3 is a schematic representation of the temperatures of actuators resulting from a method according to the present disclosure, as well as a corresponding braking force distribution on an axle according to a first example embodiment.

FIG. 4 is a schematic representation of the temperatures of actuators resulting from a method according to the present disclosure, as well as a corresponding braking force distribution according to a second example embodiment.

### DETAILED DESCRIPTION OF EXAMPLE EMBODIMENTS

In the figures, identical reference signs denote identical device components or identical method steps.

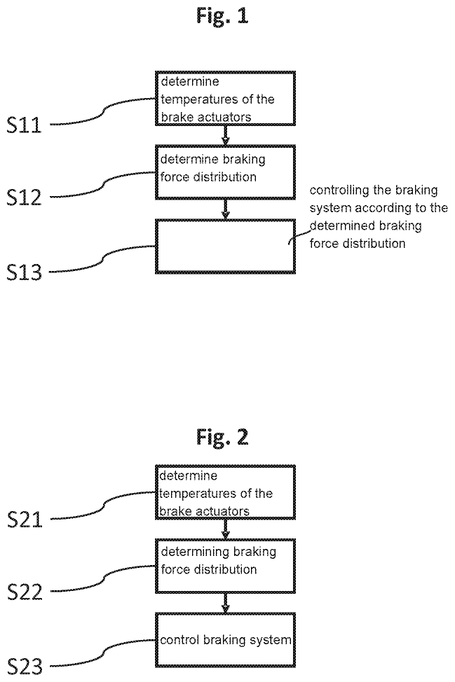

FIG. 1 is a flow chart of a method according to the present disclosure for controlling a braking system of a vehicle according to a first embodiment. The vehicle has a plurality of axles and the braking system has a plurality of brake actuators.

In a first step S11, temperatures of the brake actuators are determined. This can be done, for example, by means of a temperature sensor attached to the relevant actuator, or alternatively or additionally by means of a mathematical model that depicts a temperature development of the relevant actuator.

In a second step S12, a braking force distribution between the brake actuators is determined as a function of the temperatures of the brake actuators. The braking force distribution specifies what proportion of the braking force each brake actuator should apply.

The braking force distribution can be performed, for example, via the differences between the current temperatures of the brake actuators and predefined temperature limits. The greater the distance, the greater the potential use of the actuator without overloading it; i.e., the actuator can be used more during a braking maneuver.

In a third step S13, the braking system is controlled according to the determined braking force distribution. This can, for example, be done using an electronic stability program (ESP).

FIG. 2 is a flow chart of a method according to the present disclosure for controlling a braking system of a vehicle according to a second embodiment. The vehicle has a plurality of axles and the braking system has a plurality of brake actuators.

In a first step S21, the temperatures of the brake actuators are determined. This can be done, for example, by means of a temperature sensor attached to the relevant actuator, or alternatively or additionally by means of a mathematical model that depicts a temperature development of the relevant actuator.

In a second step S22, a braking force distribution between the brake actuators is determined as a function of the temperatures of the brake actuators. This can be done, for example, by comparing the current temperatures of the brake actuators to predefined temperature limits. For example, a characteristic map can contain information about which brake actuator then applies what proportion of the braking force.

In the second step S22, it is further checked whether the vehicle is stopped and whether a single axle is sufficient to maintain the stopped state. This means that it is checked whether the brake actuators of one axle are sufficient to keep the vehicle stopped. This could be challenging, for example, on a very steep incline, if the downhill output force is greater than the corresponding braking force on one axle.

However, if this is possible, the braking force distribution will be determined in such a way that only brake actuators of one axle are taken into account, i.e., that ultimately only the wheels of one axle will be braked. This involves switching between brake actuators of different axles, in particular a front axle and a rear axle, and/or between different subsets of actuators on one axle in order to reduce the thermal load on the respective brake actuators.

In a third step S23, the braking system is controlled according to the determined braking force distribution. This can be achieved, for example, through an ESP, which comprises an electronic control unit for the process flow.

Should all predefined temperature limits of the brake actuators be exceeded, the braking system is controlled in such a way that the brake actuators of the rear axle are subjected to a greater load than those of the front axle, in order to keep the front axle brake actuators available for as long as possible.

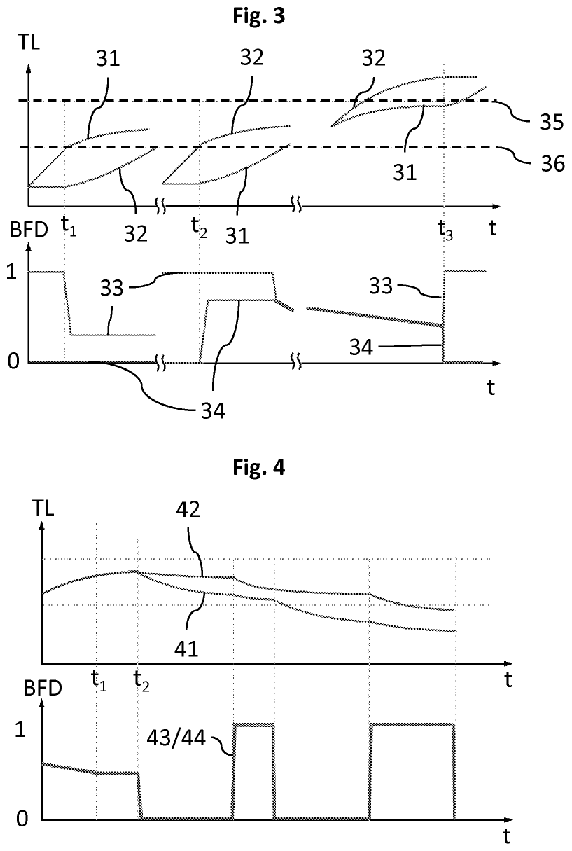

FIG. 3 shows a schematic representation of the temperatures of brake actuators resulting from a method according to the present disclosure, as well as a corresponding braking force distribution on an axle according to a first embodiment.

The upper part of FIG. 3 shows a temperature development TL plotted over time t. The first temperature curve 31 shows the temperature development of a brake actuator on the front axle, and the second temperature curve 32 shows the temperature development of a brake actuator on the rear axle. It can be seen that from a first time point t1 the temperature increase of the front axle actuator is at least slowed down, while at the same time the temperature increase at the rear axle increases. At the first time point t1, the temperature value of the front axle actuator exceeds a predefined threshold value 36 and thus a braking force distribution is determined according to a method according to the present disclosure.

Later in time, at a second time point t2, it becomes apparent that the temperature of the brake actuator on the rear axle exceeds the temperature threshold 36. Thus, the braking force is now preferably generated at the front axle actuator, which increases its temperature rise and slows down the temperature rise of the rear axle brake actuator.

At a later time point, the temperature of the rear wheel brake actuator exceeds a predefined temperature limit 35, indicating that the brake actuator will soon fail due to excessive temperature.

However, it is still functional at this time point, so the braking force distribution determined according to the present disclosure is maintained.

At time point t3, the rear wheel brake actuator fails and can therefore no longer generate braking force. Thus, the braking force distribution between the remaining brake actuators is determined without limitations on the braking force distribution, i.e., the brake actuator of the front axle can generate a maximum braking force to support an emergency stop if necessary. Any pre-existing limitations in braking force distribution are disregarded.

The lower part of the graphic in FIG. 3 shows the limitations of the braking force distribution that must be observed for the braking force distribution at the front axle brake actuator, in this case the upper limitation curve 33 and the lower limitation curve 34. A distribution between 0 and 1 is possible, where 0 means that the corresponding actuator provides no braking force, and 1 means that the corresponding actuator provides the full braking force. For example, if there is an upper limit, such as 0.5, then this means that the corresponding actuator can deliver half of the required braking force. The value range 0 to 1 thus specifies the braking force distribution (BFD) with respect to the front axle in the vehicle, i.e., minimum=maximum=1 means that only the front axle brakes. Furthermore, minimum=maximum=0 means that only the rear axle can brake. An open band, i.e., minimum=0, maximum=1, allows for a completely free distribution of braking force. The graphic thus shows a limited possible distribution of braking force. The values can therefore be interpreted as percentages.

Each axle can also have a plurality of actuators for generating the braking force, so that the corresponding braking force can be generated via a plurality of actuators.

At the first time point t1, the braking force that the front axle brake actuator can deliver is limited to prevent a sharp temperature increase that could lead to overheating.

At the second time point t2, a minimum braking force is required on the front axle, which is greater than 0, because, from this point on, the lower braking force curve 34 assumes a value greater than 0.

At the third time point t3, the limitations are lifted, and the front axle can therefore be fully loaded. This is due to the failure of the rear axle brake actuator.

FIG. 4 shows a schematic representation of the temperatures of actuators resulting from a method according to the present disclosure, as well as a corresponding braking force distribution of a vehicle according to a second embodiment.

The upper part of FIG. 4 shows a temperature development TL plotted over time t. The first temperature curve 41 shows the temperature development of a brake actuator on the front axle of the vehicle, and the second temperature curve 42 shows the temperature development of a brake actuator on the rear axle of the vehicle.

At an initial time point t1, it is checked whether the vehicle is stopped. A stopped state can also be defined, for example, as the vehicle moving at less than 5 km/h. Furthermore, it is checked whether the at least one brake actuator on one axle is sufficient to keep the vehicle stopped. Preferably, the vehicle has at least two brake actuators on each axle, for example on the front and rear axles.

If one braked axle is sufficient to maintain the stopped state, the braking force distribution is determined at time point t2, so that only the brake actuators of one axle are used to maintain the stopped state. Therefore, the temperatures of the different brake actuators decrease to different degrees.

The lower part of the graphic in FIG. 4 shows the limitations of the braking force distribution that must be observed for the braking force distribution at the front axle brake actuator, in this case the upper limitation curve 43 and the lower limitation curve 44. Both curves are identical and alternate between 0 and 1 from time point t2 onward. This ensures that only the brake actuators of one axle provide the required braking force at any given time. This serves to reduce the thermal stress on the actuators.

1-10. (canceled)

11. A method for controlling a braking system of a multi-axle vehicle, wherein the braking system includes a plurality of brake actuators, the method comprising the following steps:
determining temperatures of the brake actuators;
determining a braking force distribution between the brake actuators depending on the temperatures of the brake actuators; and
controlling the braking system depending on the determined braking force distribution.

12. The method according to claim 11, wherein the vehicle has at least two axles, each axle of the at least two axles having at least one brake actuator, wherein the braking force distribution is determined such that a thermal load on at least one brake actuator of a first axle of the at least two axles is reduced by increasing a thermal load on at least one brake actuator of a second axle of the at least two axles.

13. The method according to claim 12, wherein the determining of the braking force distribution is carried out when a temperature of the brake actuator of the first axle exceeds a predefined threshold value.

14. The method according to claim 12, wherein the first axle is the front axle of the vehicle and the second axle is the rear axle of the vehicle.

15. The method according to claim 11, wherein, when determining the braking force distribution, it is checked whether the vehicle is stopped and the brake actuators of one axle of the vehicle are sufficient to maintain a stopped state, wherein when the check is successful, a braking force is applied only to the one axle using at least a subset of brake actuators on the one axle, and wherein switching is performed between a front axle of the vehicle and a rear axle of the vehicle and/or between different subsets of brake actuators on the one axle to reduce thermal stress on the brake actuators.

16. The method according to claim 11, wherein, prior to determining the braking force distribution, it is checked whether or not recuperation of braking energy is possible, the braking force distribution being determined when recuperation is not possible.

17. The method according to claim 11, wherein, in the event of failure of a brake actuator of the plurality of brake actuators, the braking force distribution between the remaining brake actuators is determined without limitations on the braking force distribution.

18. An electronic control unit configured to control a braking system of a multi-axle vehicle, wherein the braking system includes a plurality of brake actuators, the control unit configured to perform the following steps:
determining temperatures of the brake actuators;
determining a braking force distribution between the brake actuators depending on the temperatures of the brake actuators; and
controlling the braking system depending on the determined braking force distribution.

19. A non-transitory machine-readable storage medium on which is stored a computer program for controlling a braking system of a multi-axle vehicle, wherein the braking system includes a plurality of brake actuators, the computer program, when executed by a computer, causing the computer to perform the following steps:
determining temperatures of the brake actuators;
determining a braking force distribution between the brake actuators depending on the temperatures of the brake actuators; and
controlling the braking system depending on the determined braking force distribution.
